(19) United States
(12) Patent Application Publication
(10) Pub. No.: US 2015/0362523 A1
(43) Pub. Date: Dec. 17, 2015

(54) Low Profile Multi-Axis Sensing System

(71) Applicant: Analog Devices, Inc., Norwood, MA (US)

(72) Inventor: Joseph S. Bergeron, Greensboro, NC (US)

(21) Appl. No.: 14/303,650

(22) Filed: Jun. 13, 2014

(51) Int. Cl. G01P 15/18; G01P 15/14

(52) U.S. Cl. CPC G01P 15/18; G01P 15/14

(57) ABSTRACT

A multi-axis sensor system has a first pair of first sensors mounted to a substrate, where each first sensor has a first prescribed portion forming a straight first reference line between the first sensors. Each first sensor is oriented at a first acute angle relative to the first reference line. In a similar manner, the system also has a second pair of second sensors mounted to the substrate, where each second sensor has a second prescribed portion forming a straight second reference line between the second sensors. Each second sensor is oriented at a second acute angle relative to the second reference line. The first reference line is orthogonal to the second reference line, and the first and second acute angles are greater than about zero degrees.

### FIELD OF THE INVENTION

The invention generally relates to inertial sensors and, more particularly, the invention relates to orienting inertial sensors to detect motion relevant to more than one axis.

### BACKGROUND OF THE INVENTION

Many applications require inertial sensors with high-fidelity measurement in three orthogonal axes. The art has responded to this with numerous three-axis MEMS inertial sensors for gyroscopic and/or acceleration sensing exist, including, for example, ADiS1636X series, ADiS1640X series, ADiS16375, ADiS16488, ADiS16334, ADiS16300, ADX345, and ADiS16448 inertial sensors sold by Analog Device, Inc. of Norwood, Mass.

Highest performance often is attained, however, in one or two axes, with lower performance being typical in the third orthogonal sensing axis. This limitation generally is due to the unique processing of conventional MEMS devices and the planar nature of micromachining processes. To maximize performance, a MEMS sensor design can be optimized for sensing in a particular plane; the burden is then on offering an assembly approach that is both economical (e.g., in terms of size, cost, etc.) and preserves sensor performance.

High precision inertial measuring systems that measure in three-dimensions therefore often mount three highly precise one-axis sensors to measure movement along three orthogonally oriented axes. In other words, each axis has one one-axis sensor mounted along it, and the three combined sensors provide information about movement in three axes. Undesirably, this orthogonal mounting arrangement often produces a large sensor system, which can limit its use in various applications.

### SUMMARY OF VARIOUS EMBODIMENTS

In accordance with one embodiment of the invention, a multi-axis sensor system has a first pair of first sensors mounted to a substrate, where each first sensor has a first prescribed portion forming a straight first reference line between the first sensors. Each first sensor is oriented at a first acute angle relative to the first reference line. In a similar manner, the system also has a second pair of second sensors mounted to the substrate, where each second sensor has a second prescribed portion forming a straight second reference line between the second sensors. Each second sensor is oriented at a second acute angle relative to the second reference line. The first reference line is orthogonal to the second reference line, and the first and second acute angles are greater than about zero degrees.

The first sensors and the second sensors include the same type of sensors (e.g., gyroscopes), or different types of sensors. Moreover, the sensors each may have a central region. In that case, the first and second prescribed portions of each sensor may include its central region.

The substrate may include a number of different items, such as an object (e.g., a helmet) or a printed circuit board intended to be mounted to an object. Also, the first acute angle may be about equal to the second acute angle, or different from the second acute angle. Either way, the system should detect the property it is intended to sense.

The system also may have circuitry mounted to the substrate. Among other things, the circuitry may be configured to convert the output of the first and second sensors into rotational information about three different axes. In illustrative embodiments, the first and second sensors each are single-axis sensors (i.e., they are configured to detect motion in one dimension only). As an example, each first sensor may include a MEMS device having a mass suspended above a substrate. The substrate has a bottom surface that forms the first acute angle with the first reference line.

In accordance with another embodiment, a multi-axis sensor system has a substrate forming a first portion and a second portion intersecting at a substrate intersection point. A first pair of first sensors are mounted on opposite sides of the substrate intersection point on the first portion of the substrate, and a second pair of sensors are mounted on opposite sides of the substrate intersection point on the second portion of the substrate. The first pair of first sensors forms a straight first reference line, while the second pair of second sensors forms a second straight reference line that is orthogonal to the first reference line.

The first sensors are mounted to detect motion about intersecting axes that each are oriented at a first acute angle relative to the first reference line. In a similar manner, the second sensors are mounted to detect motion about intersecting axes that each are oriented at a second acute angle relative to the second reference line. The first and second acute angles preferably are greater than about zero degrees.

In accordance with other embodiments, a method of forming a multi-axis sensor mounts a first pair of first sensors to a substrate so that they form a straight first reference line therebetween. Each first sensor is mounted to form a first acute angle relative to the first reference line (i.e., to measure rotation about an axis that is not orthogonal to the first reference line). In a similar manner, the method also mounts a second pair of second sensors to a substrate so that they form a straight second reference line therebetween. Each second sensor is mounted to form a second acute angle relative to the second reference line. The first reference line is orthogonal to the second reference line, and the first and second acute angles are greater than about zero degrees.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows an object that may be used with a motion sensing system configured in accordance with illustrative embodiments of the invention.

FIG. 2 schematically shows a top view of a motion sensing system configured in accordance with illustrative embodiments of the invention.

FIG. 3 schematically shows a side view of the motion sensing system of FIG. 2.

FIG. 4 schematically shows a subtraction circuit that may be used with illustrative embodiments of the invention to calculate rotation about the Z-axis.

FIG. 5 schematically shows a subtraction circuit that may be used with illustrative embodiments of the invention to calculate rotation about the Y-axis.

FIG. 6 schematically shows a circuit for calculating rotation about the Z-axis.

FIG. 7 shows a process of forming a motion sensing system in accordance with illustrative embodiments of the invention.

### DESCRIPTION OF ILLUSTRATIVE EMBODIMENTS

In illustrative embodiments, a multi-axis motion sensing system detects motion in multiple dimensions using higher precision, lower-order sensors (e.g., 1-axis or 2-axis sensors). To reduce the profile of the system, those sensors are not mounted in an orthogonal relationship relative to each other—instead, they are mounted non-orthogonally relative to each other, effectively providing more flexibility for mounting to an underlying object. For example, the motion detection system can mount to an underlying object (e.g., a football helmet) in a manner that orients the sensors based on the shape of the object. Orthogonal mounting is not required. Details of illustrative embodiments are discussed below.

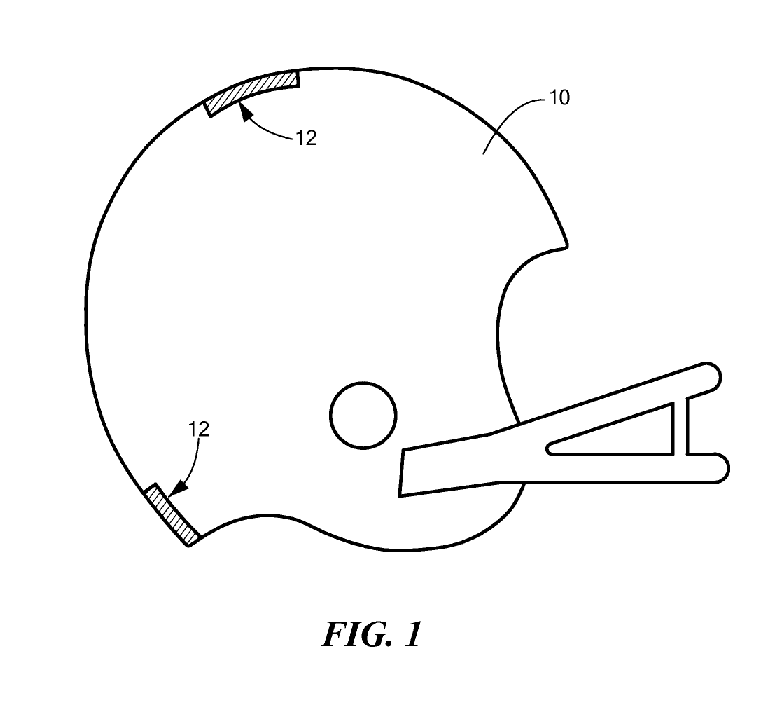

FIG. 1 schematically shows an object 10 that may benefit from a motion sensing system configured in accordance with illustrative embodiments of the invention. Specifically, in this example, the object 10 is a football helmet (also referred to using reference number “10”) having a motion sensing system 12 that detects the direction and/or impact of the helmet 10. For example, the motion sensing system 12 may detect the direction or rotation of an impact force, or the magnitude of that impact force. This has become especially useful recently in helping athletes better understand the causes and severity of head injuries sustained during athletic events.

It should be noted that although a football helmet 10 as shown, those skilled in the art can apply illustrative embodiments to any of a wide variety of different objects 10. For example, the motion sensing system 12 can be coupled with a baseball bat, a golf club, an automobile, a smartphone, a desk drawer, a drone, a robot, a package, or for any other object those skilled in the art may deem appropriate.

The motion sensing system 12 can be mounted anywhere on or within the football helmet 10. For example, this embodiment shows two different locations along the interior surface of the helmet 10. The helmet 10 preferably isolates the motion sensing system 12 from the user's head to avoid damaging the motion sensing system 12 during an impact. For example, the helmet 10 may have a recess or protected chamber (not shown) that effectively prevents the motion sensing system 12 from making direct contact with the user's head. As shown, the motion sensing system 12 may be flexible, contouring to the internal shape of the helmet 10 which, as discussed in detail below, correspondingly orients its on-board sensors 18 in a prescribed manner. In other embodiments, as noted below, the motion sensing system 12 may be rigid and set to have pre-specified contours.

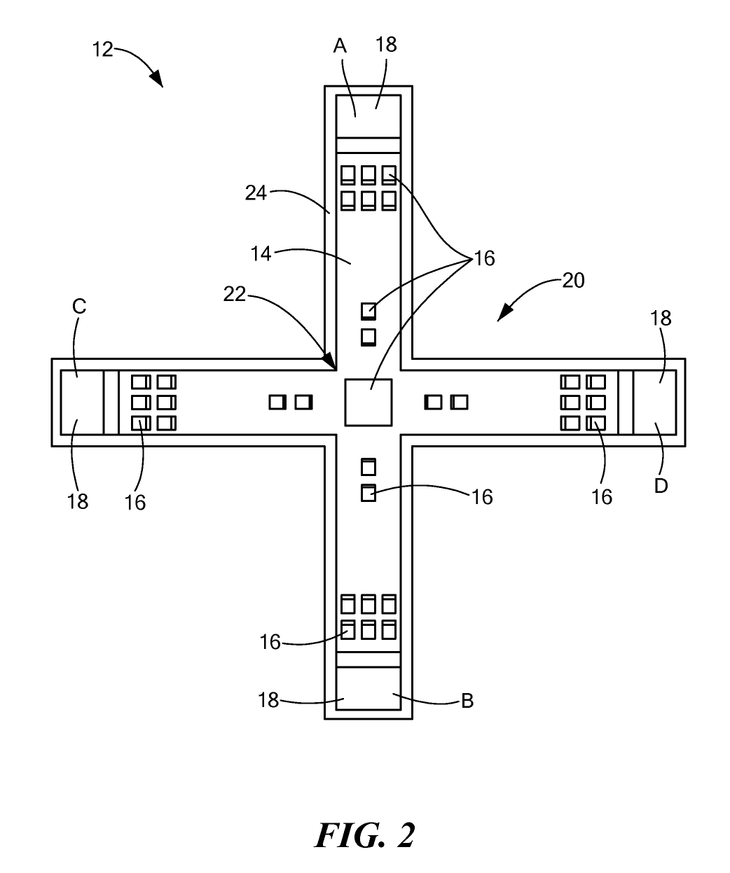

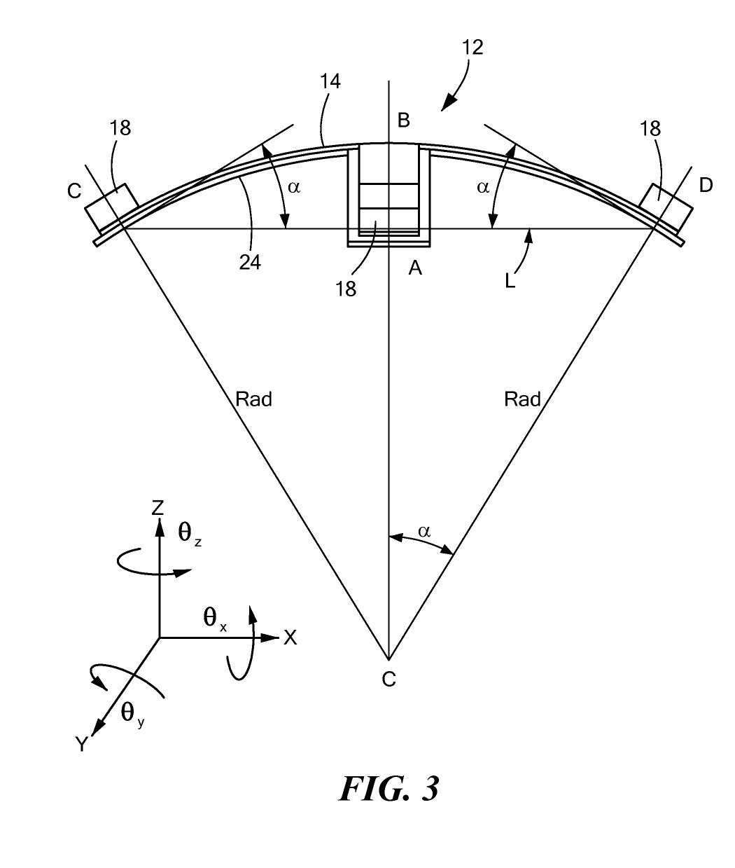

To obtain more precise results, illustrative embodiments of the motion sensing system 12 are implemented with a plurality of lower-order inertial sensors 18—i.e., a one-axis or two-axis sensor 18 (see FIGS. 2 and 3). Specifically, as known by those skilled in the art, a one-axis inertial sensor measures an inertial quality relative to one axis. For example, a one-axis accelerometer measures acceleration relative to a single axis only. As also known by those skilled in the art, a two-axis inertial sensor measures an inertial quality relative to two axes. For example, a two-axis gyroscope measures rotation relative to two axes, such as two orthogonal axes. Some embodiments, however, may use a three-axis inertial sensor 18. For example, some embodiments may use a three-axis gyroscope, but only use one or two of its dimensions.

Those skilled in the art preferably do not use a three-axis sensor, however, because one or two of the three dimensions do not necessarily have the highest fidelity output or performance. More particularly, as noted above, the highest performance of a three-axis inertial sensor often is attained in one or two axes only, with lower performance being typical in the third orthogonal sensing axis. This limitation generally is due to the unique processing of conventional MEMS devices and the planar nature of micromachining processes. Those skilled in the art therefore often prefer to use more than one lower-order sensor to detect motion along more than one axis. Illustrative embodiments, for example, use four one-axis or two-axis sensors 18.

FIG. 2 schematically shows a motion sensing system 12 configured in accordance with illustrative embodiments of the invention. The motion sensing system 12 has a flexible or rigid substrate 14 for securing a plurality of circuit elements 16 and four sensors 18. All four of the sensors 18 preferably are the same type and model sensor 18. For example, all four sensors 18 may be the same model gyroscope distributed by Analog Devices, Inc. In alternative embodiments, however, the sensors 18 may be different (e.g., the four sensors 18 may include two two-axis sensors and two one-axis sensors).

The substrate 14 may include flexible circuit board material that mounts and electrically interconnects the circuit elements 16 and sensors 18. For example, the substrate 14 may include a rectangular shaped flexible circuit (also identified by reference number “14”), an oval shaped flexible circuit 14, or a flexible circuit 14 having some other shape. In the embodiment shown in the figures, the flexible substrate 14 is in the form of a cross having two portions 20 that intersect at an intersection point (e.g., roughly the central region 22 of the substrate 14). Accordingly, the two substrate portions 20 share a central region 22 and have independent end regions that each support one of the sensors 18.

The sensors 18 may be considered to be divided into two orthogonal pairs—one pair on each substrate portion 20. In particular, from the perspective of FIG. 2, the motion sensing system 12 has a first pair of opposed sensors 18 at the top and bottom of the substrate 14 (from the perspective of the drawing), and a second pair of opposed sensors 18 at the right and left of the drawing. The sensors 18 in each pair thus are on opposite sides of the intersection point. As discussed below, the motion sensing system 12 orients the first pair of sensors 18 so that they are orthogonal to the second pair of sensors 18.

The sensors 18 may be any inertial sensor known in the art. In preferred embodiments, the inertial sensors 18 are formed using conventional micromachining technology and thus, are known as microelectromechanical systems devices (“MEMS devices”). Specifically, the MEMS devices may include a MEMS die having movable microstructure movably suspended relative to a substrate 14. The substrate 14 may have a generally planar body that is mounted within a conventional package, such as a ceramic cavity package or a pre-molded leadframe package. For example, the sensors 18 may be accelerometers or gyroscopes, such as those distributed by Analog Devices, Inc. of Norwood, Mass. under the following model numbers: ADXL103, ADXL001, ADXRS620, ADXRS640 and ADXRS649, and ADiS16448. Of course, this listing is intended to be exemplary and not limiting. Accordingly, those skilled in the art can use any of a wide variety of other inertial sensors 18, other types of sensors, or other MEMS or non-MEMS accelerometers or gyroscopes.

As noted above, the substrate 14 also supports circuitry/circuit elements 16 for managing electrical signals to and from the sensors 18. For example, as discussed below, the circuit elements 16 may condition the output of the sensors 18 in a prescribed manner that facilitates use by an external device, such as a computer or memory device. To that end, the circuit elements 16 preferably are implemented as a plurality of integrated circuits, improving flexibility and reliability while minimizing space requirements on the flexible circuit 14. Details of some embodiments of these circuit elements 16 are discussed below.

A frame 24 may rigidly support the substrate 14 at a prescribed curvature and/or orientation. For example, the frame 24 may support the substrate 14 so that its sensors 18 normally are oriented a prescribed angles (discussed below). Among other things, this frame 24 may be formed from metal (e.g., aluminum) or a rigid plastic. Other embodiments, however, may form the frame 24 from flexible material, or omit the frame 24 entirely.

FIG. 3 schematically shows a side view of the motion sensing system 12 of FIG. 2. Unlike the apparent depiction of FIG. 2, the substrate 14 is not flat when in use. Instead, the substrate 14 in this embodiment forms a curvature having an effective radius “Rad.” Each sensor 18 is positioned on, and thus, angled along that curvature to respond to motion relative to different axes. Each axis effectively is a different radius line (also identified by reference letter “Rad”) extending from an effective common central point C. Each radius line Rad has the same length if the radius of curvature of the substrate 14 is constant. If the radius of curvature of the substrate 14 is different, however, then the length of the radius lines Rad likely would have different values.

If the sensors 18 are one-axis gyroscopes, then each sensor 18 may be configured to detect rotation about different radius lines Rad—each radius line Rad acts as an axis for its respective gyroscope. As shown, however, these gyroscopes are not oriented orthogonally relative to each other. Instead, the gyroscopes are oriented so that the entire motion sensing system 12 has a lower profile and thus, fits more easily into the object 10.

More specifically, the inventor realized that by using an additional one-dimensional gyroscope (e.g., a fourth gyroscope), he could reduce the profile of the motion sensing system 12, thus enabling a multitude of additional uses. As noted above, this is most effective when the two pairs of gyroscopes are orthogonal to each other. To that end, as shown in FIGS. 2 and 3, the gyroscopes are identified by reference letters A-D. Gyroscopes A and B form one pair, while gyroscopes C and D form a second pair.

As best shown in FIG. 3, the motion sensing system 12 is considered to effectively form a straight reference line L between gyroscopes C and D—the second pair of gyroscopes. Indeed, this reference line L is just used as a reference and not necessarily a physical entity in the motion sensing system 12. This reference line L preferably extends between corresponding portions of the two gyroscopes C and D. For example, FIG. 3 shows the reference line L extending between corresponding central portions of the gyroscopes C and D. Some embodiments, however, may form the reference line L between the lower left corner of gyroscope C and the lower right corner of gyroscope D. Other embodiments may form the reference line L between other corresponding portions. In the embodiments shown, this reference line L effectively contacts the substrate 14 to form an arc. Accordingly, the reference line L does not coincide with the substrate 14—it is spaced away from the substrate 14 along the substantial majority of its length.

Generally speaking, each gyroscope C and D is oriented so that its sense plane forms an acute angle α against the straight reference line L. As shown, this acute angle is interior to the motion sensing system 12 (i.e., facing radially inwardly—not radially outwardly). More particularly, as known by those in the art, an inertial sensor 18 is considered to sense motion relative to its sense plane. For example, a one-axis gyroscope may have a sense plane through which a sense axis passes. As the gyroscope moves with a “yaw” motion along this sense plane, it measures rotation about this sense axis (e.g., radius line Rad of FIG. 3). As another example, an accelerometer has a sense plane along which it measures acceleration. This sense plane may be parallel with an axis (e.g., an X-axis). The acute angle α thus effectively is formed between the sense plane of the sensor 18 and the reference line L between the gyroscopes C and D.

In preferred embodiments, this acute angle α is greater than about zero degrees but, of course, less than about 90 degrees. In the example shown in FIG. 3, for example, this acute angle α is 30 degrees. Other embodiments, however, may form the acute angle to be approximately 45 degrees. Both gyroscopes C and D should form approximately the same acute angle.

The first pair of gyroscopes A and B also has a corresponding straight reference line L (not shown). As noted above, the first pair of sensors 18 preferably is orthogonal to the second pair of sensors 18. To that end, the reference line L of the first pair preferably is orthogonal to the reference line L of the second pair. Moreover, in a manner similar to gyroscopes C and D, the gyroscopes A and B also form an acute angle with their common reference line L.

Like the acute angles formed by gyroscopes C and D, these acute angles preferably are greater than about 0 degrees and less than about 90 degrees. For example, the acute angle formed by gyroscopes A and B can be about 30 degrees. While the gyroscopes in each pair should have the same acute angle, the two pairs are not required to have the same acute angles. For example, the gyroscopes in the first pair may form acute angles of about 45 degrees, while the gyroscopes in the second pair may form acute angles of about 30 degrees.

If the angle α is 30 degrees, the configuration of FIG. 3 should produce output signals SA thorough SD that ideally follow Equations 1 below (“ΘX” representing the rotation about the X-axis, “ΘY” representing the rotation about the Y-axis, and “ΘZ” representing the rotation about the Z-axis):

SA=cos(30°)*ΘZ+sin(30°)*ΘX

SB=cos(30°)*ΘZ−sin(30°)*ΘX

SC=cos(30°)*ΘZ+sin(30°)*ΘY

SD=cos(30°)*ΘZ−sin(30°)*ΘY Equations 1

The signals SA through SD produced by the gyroscopes, however, should be converted to the standard coordinate system shown in FIG. 3, which has orthogonal axes X, Y, and Z. To that end, illustrative embodiments use the output signals SA through SD to produce rotational information about the 3 orthogonal axes X, Y, and Z. Again, using angle α as 30 degrees, and VS as the source voltage, the inventors determined that the angle Θ of rotation about the axes follow Equations 2 below:

ΘX=A−B

ΘY=C−D

ΘZ=(A+B+C+D)/3.464 Equations 2

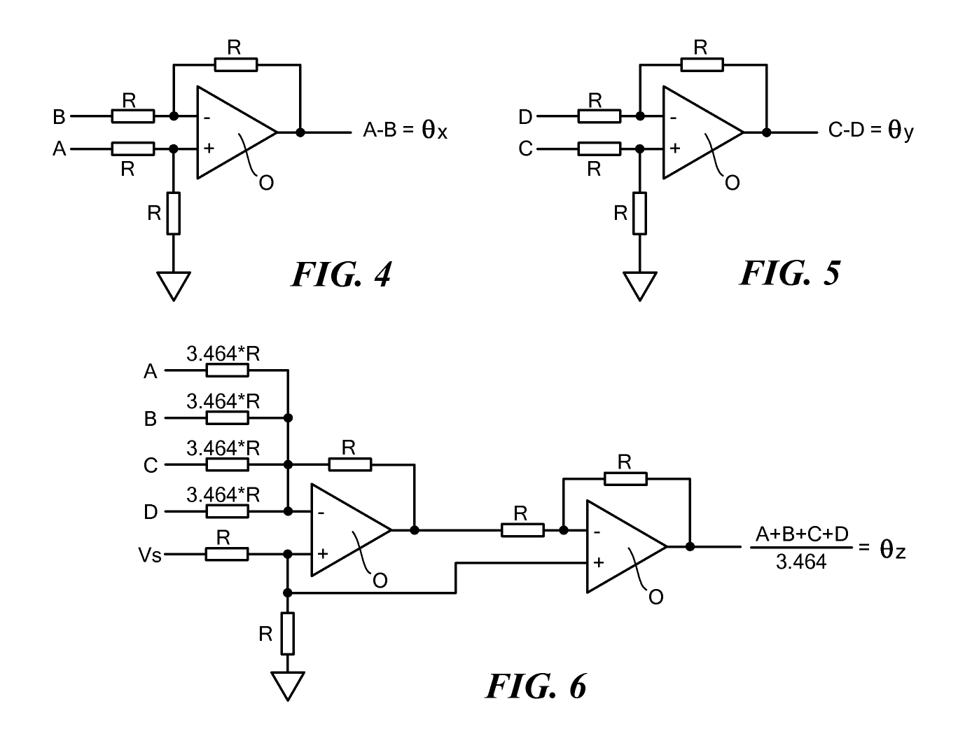

Those skilled in the art can use any of a wide variety of circuit arrangements to execute Equations 2. FIGS. 4-6 schematically show various arrangements using operational amplifiers O and resistors R for those purposes. To that end, FIG. 4 schematically shows a subtraction circuit that may be used with illustrative embodiments of the invention to calculate rotation about the X-axis. This circuit has an operational amplifier O with two input resistors R, a ground resistor R, and a feedback resistor R. All of the resistor values may be the same. FIG. 5 schematically shows a subtraction circuit that may be used with illustrative embodiments of the invention to calculate rotation about the Y-axis. This circuit is substantially identical to that of FIG. 4, except for the actual input signals it receives and processes.

FIG. 6 schematically shows a circuit for calculating rotation about the Z-axis. In a manner similar to the circuits of FIGS. 4 and 5, this circuit has a plurality of resistors R with the same value. Four input resistors R, however, have a value of 3.464*R (based on the angle α). Each input resistor R thus receives on input signal SA, SB, SC, or SD, whichever the case may be, which are all delivered to the negative terminal of a first operational amplifier O. The output of that operational amplifier O is fed to the negative terminal of a second operational amplifier O, which produces the desired output.

Indeed, the circuits shown in FIGS. 4-6 are examples of any of a wide variety of different circuits that may implement Equations 2. For example, the circuit of FIG. 6 can omit the resistors R at the respective non-inverting inputs of the operational amplifiers O and simply connect those inputs to ground. While that change may impact the output as noted in Equations 2, it should deliver sufficient results. Accordingly, those skilled in the art should understand that those circuits are not intended to limit various embodiments of the invention.

Equations 1 and 2 apply to the gyroscopic application discussed above. It should be noted, however, that similar equations may be applied to gyroscopic applications having different parameters and angles α. For example, the denominator value of 3.464 of the OZ equation is calculated based on the angle α being 30° and the motion sensing system 12 having four sensors 18 (i.e., (total number of sensors)*cos (α)). If the angle α were 45°, for example, then the denominator would differ—it would be 2.828. Accordingly, for this and other reasons, the angle α impacts the sensitivity of the overall motion sensing system 12.

In a similar manner, other similar equations may be calculated for use with other sensors 18, such as accelerometers. In fact, although they are expected to be normally combined to determine acceleration, some embodiments may use accelerometers to determine rotation. The motion sensing system 12 also may perform a function other than motion sensing. For example, the sensors 18 may include magnetometers to measure the magnetization of a Ferro-magnet, or to measure the strength and/or direction of a magnetic field. Accordingly, discussion of Equations 1 and 2 above, motion sensors 18, and gyroscopes are not intended to limit various other embodiments of the invention.

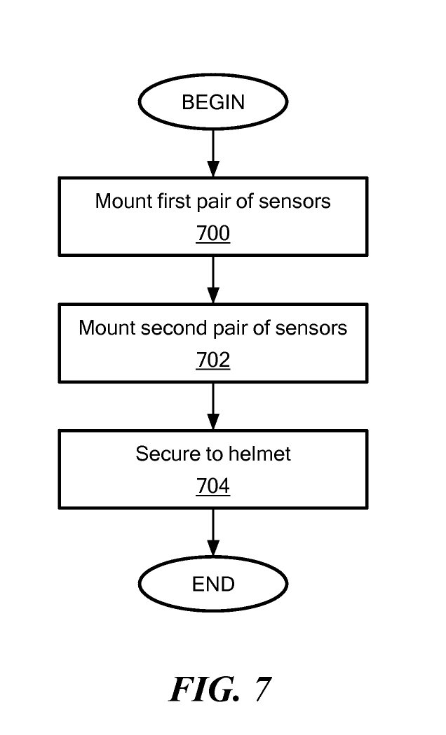

FIG. 7 shows a process of forming a motion sensing system 12 in accordance with illustrative embodiments of the invention. It should be noted that this process is substantially simplified from that which normally would be used to form the motion sensing system 12. Accordingly, the process of forming the motion sensing system 12 has many steps, such as testing steps or passivation steps, that those skilled in the art likely would use. In addition, some of the steps may be performed in a different order than that shown, or at the same time. Those skilled in the art therefore can modify the process as appropriate.

The process begins at step 700, which mounts a first pair of opposing sensors 18 onto the substrate 14, which already has the circuitry/circuit elements 16. As noted above, the circuit elements 16 preferably are implemented as a plurality of integrated circuits mounted to the surface or within the interior of the substrate 14. Those skilled in the art can mount the sensors 18 in any of a variety of manners, such as by using surface mount techniques or other related technologies. When using a flexible circuit as the substrate 14, some embodiments may mount the sensors 18 within the substrate 14.

Step 702 mounts the second pair of sensors 18 to the substrate 14 in a manner substantially identical to the manner of mounting the first pair of sensors 18. In preferred embodiments, the process executes step 700 and 702 at substantially the same time. Other embodiments, however, may execute the steps serially.

The process concludes at step 704, which secures the motion sensing system 12 to the interior of the object 10—such as the helmet 10 shown in FIG. 1. As noted above, the motion sensing system 12 is flexible and thus, orients the sensors 18 in a known manner, based on the contours of the helmet 10, to produce the desired output.

Accordingly, illustrative embodiments form the motion sensing system 12 to detect motion relative to three orthogonal axes in a low-profile environment. As such, the motion sensing system 12 is expected to be useful in a wider variety of objects 10 than prior art orthogonally oriented motion sensing systems.

Although the above discussion discloses various exemplary embodiments of the invention, it should be apparent that those skilled in the art can make various modifications that will achieve some of the advantages of the invention without departing from the true scope of the invention.

What is claimed is:

1. A multi-axis sensing system comprising:
a first pair of first sensors mounted to a substrate, each first sensor having a first prescribed portion forming a straight first reference line between the first sensors, each first sensor being oriented at a first acute angle relative to the first reference line;
a second pair of second sensors mounted to the substrate, each second sensor having a second prescribed portion forming a straight second reference line between the second sensors, each second sensor being oriented at a second acute angle relative to the second reference line,
the first reference line being orthogonal to the second reference line,
the first and second acute angles being greater than about zero degrees.

2. The multi-axis sensing system as defined by claim 1 wherein the first sensors and the second sensors include the same type of sensors.

3. The multi-axis sensing system as defined by claim 2 wherein the first sensors and the second sensors include MEMS gyroscopes.

4. The multi-axis sensing system as defined by claim 1 wherein the substrate includes a printed circuit board.

5. The multi-axis sensing system as defined by claim 1 wherein the sensors each have a central region, the first and second prescribed portions of each sensor being its central region.

6. The multi-axis sensing system as defined by claim 1 wherein the first acute angle is about equal to the second acute angle.

7. The multi-axis sensing system as defined by claim 1 wherein the first acute angle is different from the second acute angle.

8. The multi-axis sensing system as defined by claim 1 further comprising circuitry mounted to the substrate, the circuitry configured to convert the output of the first and second sensors into rotational information about three different axes.

9. The multi-axis sensing system as defined by claim 1 wherein the first and second sensors each are single-axis sensors.

10. The multi-axis sensing system as defined by claim 1 wherein each first sensor comprises a sense plane, the sense plane forming the first acute angle with the first reference line.

11. A multi-axis sensing system comprising:
a substrate forming a first portion and a second portion, the first and second portions intersecting at a substrate intersection point;
a first pair of first sensors mounted on opposite sides of the substrate intersection point on the first portion of the substrate, the first pair of first sensors forming a straight first reference line;
a second pair of sensors mounted on opposite sides of the substrate intersection point on the second portion of the substrate, the second pair of second sensors forming a second straight reference line,
the first reference line being orthogonal to the second reference line,
the first sensors being mounted to detect motion about intersecting axes that each are oriented at a first acute angle relative to the first reference line,
the second sensors being mounted to detect motion about intersecting axes that each are oriented at a second acute angle relative to the second reference line,
the first and second acute angles being greater than about zero degrees.

12. The multi-axis sensing system as defined by claim 11 wherein the first and second portions form a cross.

13. The multi-axis sensing system as defined by claim 11 wherein the first and second sensors are the same sensors and comprise one of a gyroscope, an accelerometer, or a magnetometer.

14. The multi-axis sensing system as defined by claim 11 wherein the first straight reference line is spaced from the substrate intersection point.

15. The multi-axis sensing system as defined by claim 11 further comprising a helmet, the substrate being secured to the helmet.

16. A method of forming a multi-axis sensing system, the method comprising:
mounting a first pair of first sensors to a substrate so that the they form a straight first reference line therebetween, each first sensor being mounted to form a first acute angle relative to the first reference line;
mounting a second pair of second sensors to a substrate so that the they form a straight second reference line therebetween, each second sensor being mounted to form a second acute angle relative to the second reference line;
the first reference line being orthogonal to the second reference line,
the first and second acute angles being greater than about zero degrees.

17. The method as defined by claim 16 wherein the first sensors and the second sensors include the same type of sensors.

18. The method as defined by claim 17 wherein the first sensors and the second sensors include MEMS gyroscopes.

19. The method as defined by claim 16 further comprising mounting the substrate to an object.

20. The method as defined by claim 16 wherein the first acute angle is different from the second acute angle.
